(19) United States
(12) Patent Application Publication
(10) Pub. No.: US 2018/0197246 A1
(43) Pub. Date: Jul. 12, 2018

(54) Flexponent Based Investment Instrument

(71) Applicant: Innoventure L.P., Colorado Springs, CO (US)

(72) Inventor: David K. Nienaber, Colorado Springs, CO (US)

(73) Assignee: Innoventure L.P., Colorado Springs, CO (US)

(21) Appl. No.: 15/401,975

(22) Filed: Jan. 9, 2017

(51) Int. Cl. G06Q 40/06

(52) U.S. Cl. CPC G06Q 40/06

(57) ABSTRACT

A method of funding a business enterprise comprising providing a security to investors in exchange for investment funds, wherein the security includes terms that legally binds the investor to accept future valuation of the investment determined by applying a time based mathematical model which projects a later value of the investment based on the value of the investment at the time it was made, and based upon a variable to be determined at consummation of a later round of funding.

### BACKGROUND

Funding cash and maintaining sufficient access to cash funds long enough to keep or to get a company into a positive cash flow position can be one of the biggest challenges any CEO or corporate officer can face, in any company. This challenge is often compounded for startup companies, having little track record and often little or no cash to begin with. This all by itself, causes potential investors to consider such companies as a high risk investment, and reasonably so. There are also many other risks associated with a startup. Are the products well defined and targeted? Are the sales projections accurate? Is the team well formulated and functional? Is there any Intellectual Property? Is the IP well defined and managed?

There are many books written covering how to characterize the risk factors involved with investing in any particular start-up. One major risk factor is always the risk of whether or not a given start-up will be able to obtain funding sufficient to meet its goals, and become a profitable company. This funding risk can be related to other factors, as investors may often be made wary by other factors not lining up, resulting in a lack of funding. However, there is also a significant portion of this risk that can be considered to be independent from all other factors. Regardless of how well thought out, planned out, and overall awesome a start-up may be, there is always some luck of the draw factor to obtaining funding. While I must coalesce to the probability that there is some degree of random luck to this matter, it is this authors belief that this random factor is generally small, and that more often than not this factor is used post mortem, to comfort those involved with a failure to fund, but also thereby tends to mask more real underlying factors. Generally, it seems that there are things that can be done to minimize the effects of underlying and random factors, and the novel concepts described herein, are in the pursuit of this goal.

For the purposes of this analysis, risk will be broken into two different components. One component, the funding risk, we will define to be the risk involved only in acquiring funding at each step of the process toward the start-ups goals. The other risk component will include all of the other risks involved with getting a start-up to its goals, the non-funding risk. The reason for breaking the risk up this way, is because the focus of this writing is the introduction of a new financing construct, a new financial instrument or method. One of the motivations for introducing this new financial method, is to minimize the risks associated primarily with funding risk. All of the other risks, are by definition not directly dependent on the funding issue per say, and are less likely effected by a new method of funding, or by a new financial instrument. That is not to say non-funding risks are irrelevant to funding, both risk types, and clearly all risk factors, play a significant hand in the valuation of a startup, and therefore relate to funding. Furthermore, funding certainly makes it more likely, that any of the hurdles and risks that a startup will encounter, will be overcome. It is virtually impossible to overcome risks and hurdles without funds. However, non-funding risks are generally independent of funding, meaning that while funding might be affected by non-funding risks, non-funding risks are not directly affected by a funding event. In other words, non-funding risks are not automatically reduced when a funding is achieved, but rather the funds acquired are then applied over time to the ongoing reduction of non-funding risks through daily execution toward a startup's goals. Conversely, once a given level of funding is achieved, funding risk is immediately reduced. Funding risk is defined as the risk that funding might not be achieved, so once each funding is achieved, the funding risk must drop accordingly. First, we will consider some of the factors contributing to funding risk.

The funding negotiation process is affected by so many different things, agreed upon valuations can vary tremendously depending upon recent developments, perceived values, the perceived and the real networking connections represented by the principals within an organization. If an agreed upon valuation is acted upon, if it was low, perhaps the investor got a good “deal”, if it was high, perhaps the entrepreneur swung a good “deal”. If these effects are large, it is this author's belief that either of these extremes tends to interfere with the success of the start-up.

If one is buying a used car, there is no ongoing relationship implied in the deal. In this situation, both buyer and seller will go their separate ways after the deal closes. As time goes on, each may or may not be happy about the deal they made, but they will not have any reason to be in an ongoing relationship, and will generally both go on their own separate ways. In this situation, I would suggest that the ability to swing the best “deal” is indeed a valuable skill. However, in a start-up, there is an ongoing relationship, one in which all parties should be hoping for a big win. All parties need to be pulling together to achieve that win. And, as is the case in most long term business relationships, the smart player should be seeking only win-win scenarios. In fact, only a win-win scenario is truly acceptable.

Valuation is a key influence in determining any funding arrangement. If there is a big gap between founders and funders in what they believe the pre-money valuation of a start-up should be, it makes coming to an agreed funding arrangement virtually impossible. If through discussions, there begins to be overlap, a deal might come together. Often this matter of valuation has a high degree of variability to it, subject to various personal interpretations of an otherwise common set of facts.

These problems are exacerbated in the early days of a start-up, during seed funding rounds. Later, once there is more money involved, a higher amount of work is justified in defining the value of the start-up. There is also more history of the start-up and more work product upon which a clearer valuation can be based. Further, during later funding rounds, there are generally more interested parties, bringing a higher diversity of perspective into the valuation process. This is still not like an open free market, or like a stock market, where there are so many people involved that it is best to just realize that the market essentially defines the value of the company on any given day. However, it is perhaps more like the housing market, where a good approximation can now be made of the value, and it can be offered for sale near that value, and eventually, someone who wants that specific home will negotiate for it, and a sale will result, establishing a real valuation. This is a situation somewhat like the situation faced by a start-up when approaching an A round. This situation is much more well defined than the situation faced by founders and funders in most seed rounds. During any pre A round, it is very difficult to get to any market driving valuation, and so it is very difficult to get any valuation to be a very robust or believable reference.

So, generally, during early phases, start-ups are very non-liquid investments. They then typically proceed to become increasingly liquid, as risk is reduced, as larger investment is made, as they increase in product definition, as sales increase, as more people become involved as investors, and more people become involved as employees. Risk continues to drop, and generally liquidity continues to increase. However, during early stage and seed rounds, there is still relatively high risk, and investment is not at all liquid. Any investor must be prepared to wait a substantial period, before it is reasonable to expect any kind of cash return. Such a start-up may well have an enormous upside potential, but it is going to take significant time to realize that potential. A lack of liquidity, and lack of a liquid market always tends to generate widely varying and generally lower valuations of a non-liquid asset.

Early funding also tends to be very quantized, that is it tends to occur in discrete funding events. This is partly due to the intense effort involved on the part of the entrepreneur. The entrepreneur cannot spend all of his time looking for money, they have to stay focused on the daily execution toward the company's goals. However, the quantized nature of early funding also happens in part because of the expense of preparing valuations, and preparing presentations in support of valuations and due diligence leading to funding.

In an early phase, or seed round funding, valuations, or at least perceived values, can be profoundly affected by discrete events, whether a particular patent issued, or whether a letter of interest was gained from a key potential customer. There is so much variability, with valuations so affected by various significant accomplishments, or the lack thereof. A longer term: perspective is easily lost, and some very errant valuations can become ensconced into funding agreements, that then cause the parties to be inequitably credited, leading to imbalances of equity among the parties. Often these inequities can lead to very different sets of expectations for follow on rounds, and to so much dissatisfaction, that they can ultimately cause the start-up to fail to obtain follow on funding. All of these factors contribute, and can exacerbate funding risk.

Frequently, a start-up can be in need of cash, and the leverage of new money can cause recent funds to obtain too good of a deal, which in itself can sometimes kill a follow on funding, or at the least can raise the tension of founders and demotivate them to the place where they cannot execute as effectively. Execution is always critical for a start-up, so clearly, any such situation is not in anyone's best interests. Yet, this longer term perspective does not always get factored into anyone's thinking when the exigent demands of closing a deal or obtaining the next round of funds are faced, People tend to stretch too much to make a deal, and then living with the bad or less than balanced deal can become too much of a burden.

Then there is the case where some recent good news has made A round funding seem nearly certain and imminent. Some investor might be anxious to get into the game, and sometimes it works out. However, what if the recent good news gets mitigated by some other affect or development, in the interim? The company might still be more or less on target, but the recent money is not satisfied with the now less than ideal terms obtainable from a source of A round funding. Depending upon how much control or influence the recent money has on the situation, this could wind up killing an A round deal, pushing a start-up closer to the edge.

Another circumstance is the common down round case. Due to some recent development, or perhaps a failure to execute to certain milestones, additional funds must be obtained during a phase in development where the start-up doesn't look so shiny. Because of this, the founders and earlier funders have to take a hit in their equity position relative to that of the new money in the deal. However, often this not so shiny appearance was built into the situation, yet was hard to predict. There may well be no real failure involved, just a typical unexpected discovery that the start-up was bound to experience, and yet because somewhat random timing effects, it happens just before a funding rather than just after, yet relative equity positions are shifted. These type affects can often be generated by random factors, and regardless of which direction they shift valuations, they tend to cause inequities that propagate, and can have a significant deleterious effect on the outcomes for all involved.

For more mature companies, they simply have more size and more presence, more ballast if you will. There are more people involved generating more accomplishments, with more developments happening along the way per any given period of time. Far more than there are for an early stage company. This all by itself gives more opportunity for positive leaning random factors to offset negative leaning random factors, and to generally smooth out a valuation curve, which shows the value of the start-up over time. There is more opportunity to show outperformance against some milestones, to offset underperformance to others. However, for early stage startups, there is little ballast, with every discrete event tending to move perceived valuations, expectations, and projections all over the map. However, the only real data available comes in bits and pieces, making it very difficult to maintain a longer term perspective on valuation, particularly when negotiation rigor and drama are added to the equation.

As one considers all of the factors that contribute to funding risk, there are some profound consistency to all of them that begins to form. All of the factors have high levels of variability, each tends to be hard to determine and measure. We know that once some early round of funding has closed, that the funding risk has dramatically dropped, but what really changed in the execution history of the start-up? The only real answer to this question is that, at least from a long term perspective, nothing has changed. This is a very important realization. Funding risk, as we have defined it here, is definitely something that is often perceived, but rarely or never firmly defined or characterized. The reason for this, is that it has no real long term basis in reality at all. It is partly formed of fear that funding will not occur, it is formed from over analysis of small amounts of data. But, in reality, any long term perspective must simply exclude funding risk from consideration, in order to be accurate, because from a long term perspective, real risk is reduced through daily execution toward real and valuable goals.

Risk plays a big part in investing in any company, large or small. Perceived risk has a big impact on the daily fluctuations of the price of the stock of any publicly traded company. While many people like to analyze public opinion and play the stock markets in accordance with the many factors which effect perceived risk, other investors prefer to invest primarily in view of fundamentals, metrics of past performance that can be measured and calibrated, and suggest whether a current valuation of a public company is high or low, a sucker play or a bargain. While no one ignores daily perceptions and price fluctuations, if one plays over a longer term in accordance with fundamentals, it is often seen as a more conservative and perhaps more stable or certain way to invest, over the long term.

Previously, there has simply been no equivalent conservative investment approach for startups. For a startup, there is often insufficient historic or execution based data from which to ascertain a value, easily. It is generally too soon for complete data to be available to support any traditional fundamental analysis, although there may be some metrics available which can be obtained from data collected on other similar companies. Getting such data can be time consuming and expensive. Often it is helpful to hire a valuation expert to establish a value for a start-up, they will often have greater access or knowledge of how to access more benchmarking data, but such experts can be expensive. This may be a viable option if there will be several investors closing on a round at the same time, but sometimes early investors want to invest smaller amounts at various different times, spread out over a year or two. This can quickly make hiring an expert prohibitively expensive, because any given valuation is often only deemed precise or accurate for a short window of time.

The nature of the effect of risk on valuation is also fundamentally different for a startup. Risk is all about a lack of certainty, unknown factors, under defined or illusive factors. For publicly traded companies risk is generally understood to be the uncertainty of how well or poorly the share price can be predicted in advance. This is separate from an indication of the best or perhaps a mean estimate of precisely how the company's stock is most likely to do. This risk is more an indication of the variance of the predicted outcome around some most expected or mean outcome. With the distribution of possible outcomes varying around that expected mean. However, for start-ups, the variability of the possible outcome often tends to exceed any mean expected value, covering a much wider spread of value. This is so much so, that it is hard to even identify a mean expected outcome. Even when hiring a professional valuation expert, the resulting value should be understood to be some best estimate mean value, and that the actual value could fall anywhere within a fairly wide range of values around the determined value.

Any given valuation is all about a factoring in a multiplicity of discrete factors that each contribute to and have a large impact on valuation, but each of the factors can have a large variability of their own, this further contributes to the value of an enterprise being so wide spread, that the probability of any one particular value outcome occurring is too low to take seriously. This is often the case with start-ups, and early phase investments. When a valuation of an enterprise has these characteristics, increases in the value of securities in the enterprise tend to occur primarily by reducing the uncertainty or variability of contributing factors, while maintaining significant likely hood of a very positive or large upside outcome. Any increase in clarity about where the company stands as a competitor, even if it is confirmed to be mediocre, tends to firm up and can increase value. This remains true even though the valuation tends to be distributed over a very large range of possible outcomes. So, the high level of variability and wild unpredictability of the outcome, becomes the real limiter to current valuation. In this circumstance, investors become more confident to give an enterprise a higher valuation as hurdles are overcome, and as some of the wildly varying contributing factors become more established, and more constrained. For example, as patents applied for actually issue, or as technology becomes more proven, or as a new management team continues to prove itself capable at overcoming obstacles.

The target market might be large, and the potential profits enormous, but the success of any start-up, as compared to the risk of investment in publicly traded companies, is considered a long shot. Venture Capitalists do their best to cherry pick among potential investments, but even with this factored in they only expect to actually win big on 1 of 10 investments. So, they invest in many different startups, and count on the returns being very large for the few cases where they do win big. So, the wins in the few cases tends to more than offset the other losses and occasional near break-evens of their other start-up investments. For winning VCs, this strategy still provides an overall good return.

So, with start-ups the risk is a much higher factor in the valuation of the company, much larger than any other factor, with the reduction of risk often being the primary factor in an increase in value. If a start-up company is progressing well, the risk is generally dropping dramatically over time. This generally dropping risk, is typically understood to be the main reason why the value of such a startup generally increases over time. The risk and the value tend to be inversely related. The value of the startup is based on the probability of the desired outcome, that it will make it through all of the major hurdles and approach the extremely high valuation that the VCs and other funders and founders are hoping for. The more hurdles that remain, the higher the risk, and the smaller the portion of that ultimate valuation which gets attributed to the company currently. This becomes the basis of an analysis to establish an A round funding.

Prior to A round, in an early stage venture, the risks are much higher yet, and the value is much more difficult to establish. Funding risk as we have defined it above is a larger factor, and real data is scarcer. Valuations that do occur for early stage funding, tend to have more variability, and thereby often result in more inequities, which all by themselves tend to increase the funding risk of the early stage startup, which might never get to an A round funding. The problem is that the high risk, the under defined and highly variable nature of early stage valuation, and timing issues tend to complicate the negotiation process, and inhibit positive outcomes. It is unlikely that all of these matters can be fully resolved, but the funding risk in getting to an A round can be significantly reduced, if a better job of characterizing evaluating and mitigating these risks can be done, and be brought to bear on the valuation process of the early stage startup. In fact, as mentioned earlier, funding risk should disappear altogether from a long term perspective, because it has no real long term source of existence. It is purely a product of the undefined or under defined nature of a start-up, which over time will certainly disappear, if the start-up continues to execute on its goals and reduce real risk factors.

To some extent, like many things, a start-up as a whole can be considered as merely representative of the sum of its parts. In this way, it is reasonable to see that the value of a start-up could be, and often is estimated based on a sum of all the contributions from all people that have made significant contributions to the start-up. This works particularly well as long as all contributions are included, whether those contributions were in the form of time and effort spent, money, ideas, perspective, or guidance. Developing a valuation of a company or of a joint effort as a sum of all of the values of multiple contributory factors, is fairly common. This has been used by many to establish a valuation of a firm or of some joint effort. However, as with all typical valuation methods, they only establish the value of a company at a particular point in time. Establishing the value of a company at a given point in time, does not establish the value of the company in the past, nor does it establish a future value of a company. It is often hard enough, after much analysis, to establish a value for any company at a given time, particularly when they are in an early phase, possibly even pre-revenue.

However, in order to equitably compare and relatively weight the contributions of many different people, all of which occur at many points over a span of time during the early phase of a startup, one would have to establish a value of all previous contributions, and indeed a valuation of the company, at many different points in time. Practically, since valuation is itself an expensive process in both time and money, such valuation tends to only occur at points in time when someone decides to invest a significant amount of cash, significant enough to justify the cost of a formal valuation. Upon these occasions, the valuation can still have major over estimates or underestimates of value, thus creating significant inequities in the resulting ownership of the company. Furthermore, many contributions to the company and its success tend to happen a little bit at a time, over a long period, particularly the contributions of founders and of team members, and early investors.

### DESCRIPTION OF THE DRAWINGS

FIG. 1 is a set of curves showing investment Value over time, Family of Curves for Single Investor, Simple Interest (Linear Model).

FIG. 2 is a set of curves showing investment Value over time, Family of Curves for Multiple Investors, Simple Interest (Linear Model).

FIG. 3 is curves showing investment Value over time, Family of Curves for Multiple Investors, Compound Interest.

FIG. 4 is a set of curves showing investment Value over time, Family of Curves for Multiple Investors, Continual Compound Interest (e curve).

FIG. 5 is a set of curves showing reduction of risk over time, Family of Curves, negative exponential.

### DETAILED DESCRIPTION OF THE INVENTION

A profound solution to this conundrum has been found, by working toward establishing not a single valuation for a start-up or for an enterprise, valid at a single point in time; but rather a time based valuation curve for an enterprise, applicable to any enterprise, and valid at any time prior to a market determined valuation, which typically gets established at A round. Applying a reasonable mathematical time based equation or model, can effectively establish an equitable value for a start-up or enterprise at any point in time, essentially forming a time based curve of the value of the enterprise. Such a curve can be deemed to represent a good reference as to the value of the enterprise continuously, at every point in time during the entire early stage, seed round, or pre-A round stage of the enterprise, by building the equation and its enforcement into a funding document thereby defining a security in the enterprise. This is easily done contractually, yet no one has done this previously, because the advantages of this approach have simply not been understood or concisely visualized until now; reinforcing the novelty, the value, and the patentability of this technique.

A time based model is a mathematical model that provides a value for some parameter at any point in time. This can be applied to the valuation of a company by inflicting a time based function upon the value of the company, and include factors which can be adjusted to cause the time base value curve to project a later value that matches a more typical, complete, or formal valuation of the company at some later point in time. If the variability over time is reasonably represented by selecting a reasonable time based model, and if it is made correct at least at one point in time, then there is reason to believe that the curve is reasonably representative of the value of the company at each point in time.

To select a mathematical function to define a company's value curve. It is a general expectation of all start-up ventures that the start-up will increase in value over time. While this is probably generally true of successful start-ups, it is clearly not a forgone conclusion. Yet, no one sponsors a start-up as a founder or investor, unless they expect the start-up to increase in value over time. So, at least in terms of expectations, having a model that has an upward sloping value with time would seem necessary for any model to be widely used or adopted, or applied to create a start-up valuation over time.

Perhaps the simplest mathematical model that increases over time, would be a linear model, a straight line with a positive slope. An example of this would be LV(later value)=IV*(1+x*t), where the later value (LV) attributed to the company at any future time from a given investment, would be the value of the investment when the investment was made, or Investment Value (IV), times (1 plus some slope factor x times time), where time is the amount of time that has transpired since the investment was made, and x remains an undetermined variable.

The great equalizer in terms of units, when combining dis-similar units such as apples and oranges, is often a currency. This is because apples and oranges, while being quite different, each cost some defined amount in any given currency. So a combination of apples and oranges, if they must be reduced to a single metric, might be best described in the value increment of some currency. Generally in the US, that currency would be US dollars. With a start-up, any contribution from anyone can be translated into a dollar value somehow. It is reasonable to consider that the composite value of a start-up at any point in time to be some combination of all previous contributions. Applying this concept to our model of a start-up value is another novel and inventive feature.

Consider using the linear model mentioned earlier, in combination with the whole being the sum of the parts feature. If each contributor to the start-up were to receive an equity position in the start-up, that was deemed to have a value that was equal to the size of each contribution of each contributor plus some slope factor or variable that is multiplied by the time that has elapsed since the contribution was made, so that each contributor receives increasing value with time based on each contribution made, all of these contributions over time could then be further added up to form a composite value for the enterprise, based on all of the contributory factors. This contributory factor based valuation would also be increasing over time, since each of the contributing factors are increasing, and also increasing as additional contributions are made. So the overall value of the company based on the contributory factors would not generally be linear, but increasing at an ever increasing rate, even as each discrete contribution was increasing in value at a linear rate. Although it would increase linearly during any period where no additional contributions were made, this is not actually very common, since effort contributions are typically happening daily among founders.

Generally, one might expect that the slope factor would be determined in advance, as funds or contributions are received by the company. Further, one might expect that the slope factor should be the same for all contributors. If two contributors each gave similar funds into the company at approximately the same time, it would seem reasonable and expected, from an equitable perspective, that each would receive the same increase over time relative to the size of their contributions.

As pointed out earlier, the valuation of a company has more of a market driven valuation factor that comes into play once the company gets to an A round. The pre-money valuation for A round funding generally gets determined as part of the overall negotiation process associated with acquiring A round funding, which occurs between the company and the source(s) of A round funds. This essentially becomes a market based valuation at that point.

If the slope factor of our contributory factors valuation is chosen and fixed at the time of each contribution, there would be no reason to expect that the total contributory valuation would match up with a pre-money valuation established by negotiation for A round. However, this is where another novel solution can be brought to bear to help match these two different valuations. One novel solution, would be to choose not to establish the slope factor of the contributory factors in advance of A round, but rather leave this factor as an undetermined variable, perhaps bracketed within a range of values, with a specific value to be established at A round. Then the value for this slope factor variable could be chosen at A round, such that the total, contributory based, composite valuation of the company is adjusted by that selection, to be equal to the A round pre-money valuation, or perhaps to be some fixed portion of the pre-money valuation. The variable would still be the same for all contributors, so that each contributors contribution gets valued using the same variable, and each contributor then receives an equitable portion of composite value for the enterprise that matches the pre-money valuation at A round. Each contributor probably receives their equitable portion of composite value in the form of common stock, to be issued at the A-round closing.

With the slope factor being a variable that gets determined at the end of the seed round, essentially at A round funding, this enables this sum of contributory factors approach to the valuation through the early seed round funding, to become both market reasonable and equitable throughout the early phases of funding. Using this approach, causes relative contributions to relate directly to relative equity positions received at A round, in a way that is most equitable, accounting for time related gains and risk factors at the time investments were made equitably for all contributors. This greatly simplifies the negotiation process for these earlier rounds, and brings a sort of big picture sense to the entire valuation curve during the early phases. This regularity or big picture sense to the early phase funding brings a far more regularized long term investing approach to these early phase funding rounds, similar to investing in publicly traded shares based on fundamentals rather than speculating based on perceived values and public mood swings. Making the valuation more regular, clearly reduces funding risk factors, giving both funders and founder's confidence that they are making a balanced deal in support of a win-win scenario throughout the early funding phases.

Throughout the early stage pre A round phases of a start-up, committing to a time based equation with an undetermined slope or interest factor, is then not actually a commitment to a single curve, but to a family of curves, all having a similar shape, but having different slopes at any point in time. This slope can then be determined once a more market driven valuation for the start-up can be achieved. Once the slope factor is chosen, then the value at any point in time is determined by the single curve from the family of curves that results in matching the pre-money valuation at the A round.

The first step in developing this valuation equation or model or family of curves, is in defining its shape over time. How should it change over time? Generally, the hope of any equity holder in any enterprise anticipates and expects the value to increase over time. While this does not always happen, for a start-up venture to continue, clearly its value must be increasing in order to justify continued effort and investment, unless it were to begin to satisfy its investors by paying funds back to the security holders in the form of dividends, or buying back securities, neither of which are generally an option for a start-up still seeking additional funding. Therefore, it is reasonable to limit the shape of our valuation curve to be one that is generally increasing over time. The simplest curve that fulfills this requirement would be a straight line, having a constant positive slope over time. This is essentially a curve representing a simple interest circumstance, where the value increases at some constant rate over time, as interest accumulates.

To define any specific line, it is necessary to find or define one point that is on the line, and then either find a second point that is also on the line, or define the specific slope of the line. Basically, either two points define a line, or a line can be defined by a slope-intercept formula.

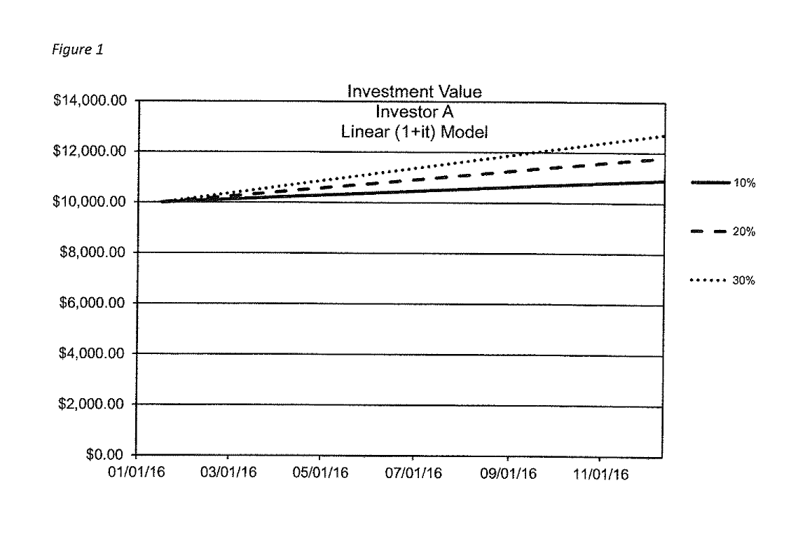

One point on any curve which defines the value of an investment is established the day of investment. Clearly, the value of any particular individual cash investment in any enterprise, the moment the investment is made, must be equal to the value of the cash investment. This establishes one point on the line. The other point will not get firmly establish until the day the negotiated pre-money valuation at A round funding establishes a composite value for the entire enterprise, and the sum of all of the individual investment projected forward with the linear model. This situation is depicted by FIG. 1 which shows a family of curves, (or straight lines in this linear case), that all intersect the initial investment value of $10,000, for Investor A on the date of investment.

It is fundamentally equitable for all investors in the enterprise to receive the same interest rate for their investments. So, at A round funding, the slope value for all of the individual investments gets chosen to cause the total enterprise value to match the pre-money valuation, while adjusting all contributors interest rate to the same value.

To consider the effects of multiple investors or contributors, on various different valuation curves, we will define a simple multiple investor fact pattern to use as an example, as follows: Investor A invests $10,000 on Jan. 16, 2016. Investor B invests $5000 on Mar. 16, 2016, and investor C invests $20,000 on Apr. 25, 2016. Each receiving a security in exchange for their investment.

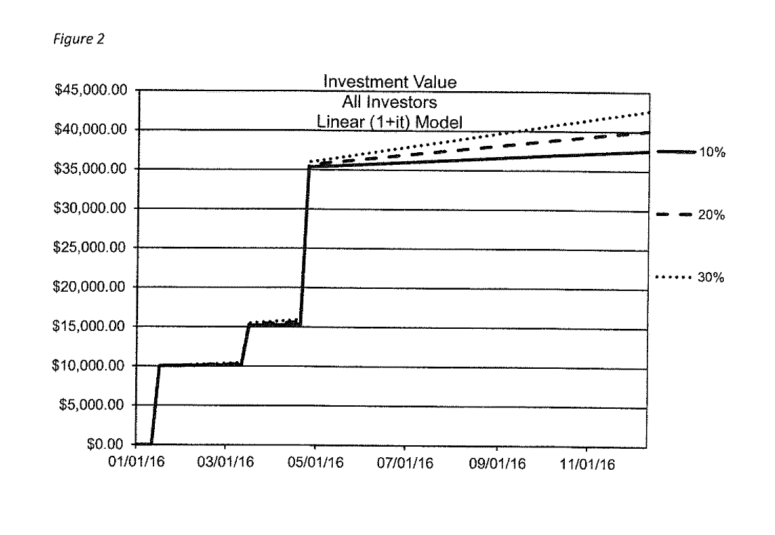

Applying this fact pattern to a linear or simple interest valuation model, results in the graph of FIG. 2.

The linear model, representing simple interest has a fundamental disconnect with the best interests of investors. Very few investments vehicles operate off of simple interest in this modern age for the same reason. If one considers two different investors, one invests $1000 at a 12% annual interest rate for one year, from Jan. 1, 2015 to Jan. 1, 2016, his investment will have grown to $1120 in value, using simple interest. If a second investor then invest $1120 at the same 12% interest on Jan. 1, 2016, he will also receive 12% and his investment value will grow to be worth $1254.40 on Jan. 1, 2017. However, with simple interest the first investor, will continue to receive 12% of his original investment for each year, so his investment, which was clearly worth $1120 on Jan. 1, 2016 will be worth $1240 on Jan. 1, 2017. So, the first investor looses $14.40 relative to the second investor through 2016, even though the size of each ones investment was the same on Jan. 1, 2016. This is clearly not an equitable situation. If the amounts involved were significant enough, the first investor would be likely to want to withdraw his funds from the investment on Jan. 1, 2016, just to reinvestment them anew the next day, just to reset his annual interest to be the same as the second investor. This problem can be resolved by changing over to compound interest. For this example, the discrepancy is resolved, if the interest is compounded annually. However, particularly for large investments, significant interest can be effectively lost during shorter intervals, by a failure to compound. For this reason, most investments and loans tend to compound at least monthly, if not daily.

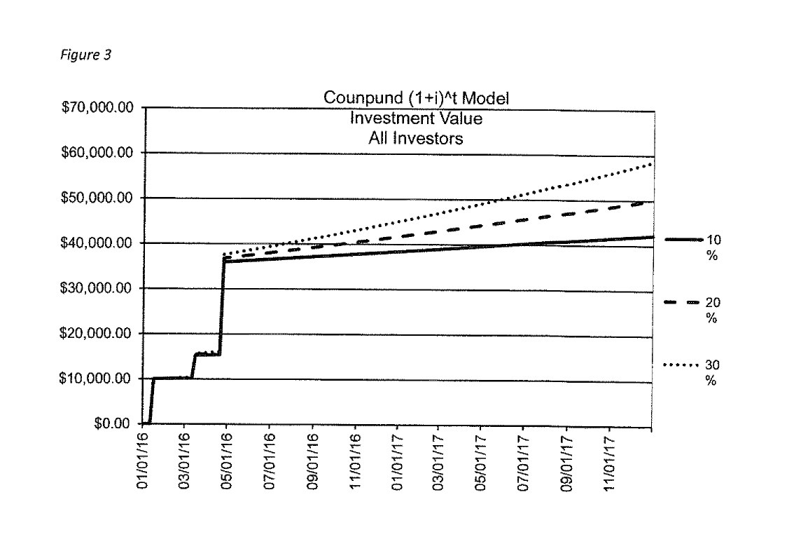

The effects of compounding can easily be added to our Investment Value model, as seen in FIG. 3. Note, that the value over time is no longer straight lines, but are now upward sloping curves. Nonetheless, the initial value for each investor is still equal to their contribution, and the slope of the curves at any point in time can still be increased or decreased by adjusting the effective annual interest rate, i. So, for these curves, the interest rate, i, will become the variable that gets modified to cause the composite value of the enterprise to match a market based valuation.

Prior to the ubiquitous availability of electronic computing, banks used to only pay interest in stepped amounts. Generally, it was most convenient to keep the payment period synchronous with the compounding period. If you withdrew your funds prior to the date the interest was deemed added, you simply forfeited any interest on the withdrawn funds that may have otherwise been due since the last day the interest was calculated. It was just too cumbersome to calculate the more subtle effects of compounding over a partial compound period. However, now it is easy to generate the smooth curve over a compounding interval as shown in FIG. 3, and still achieve exactly the target annual interest rate, upon the completion of a full year. Note, the variable t as used in our equations throughout this document up until now, is time expressed in years since an investment is made. So, t=1 on the 1 year anniversary of an investment. To create these graphs within a spreadsheet, the “t” of our equations is therefore replaced with (the date of the horizontal axis minus the date of investment).

After electronic computing devices became more readily available, banks began compounding interest daily, which meant they also began adding the interest daily. Typically, the interest added each day was the annual interest rate, i, divided by 365 days in a year.

In the field of mathematics, there are constants or numbers of unique interest, due to their fundamental relationship to functions that occur naturally in the world. The number pi is one such number, another is Euler's number, generally referred to as the number e, which is approximately 2.718281828. This number often gets utilized in equations relating to interest rates and the time value of money because it is naturally and fundamentally related to such, as we shall see.

A general equation used for the value of an interest bearing investment over any number of periodic compounding period per year “c”, is V=P(1+i/c)̂yc. Where V is final value, P is principle invested, I is annual interest rate, and c is the number of compounding periods per year, and y is number of years. So, for monthly compounding, V=P(1+i/2)̂12y. If one were to take this equation to the limit, as c goes to infinity, this equation becomes V=Pêit. This case is often referred to as continual compounding, because the compounding period has gone to zero as the number of periods per year, c, is taken to infinity. This equation for continual compounding is the reason the number e is so fundamentally related to the application of interest rates.

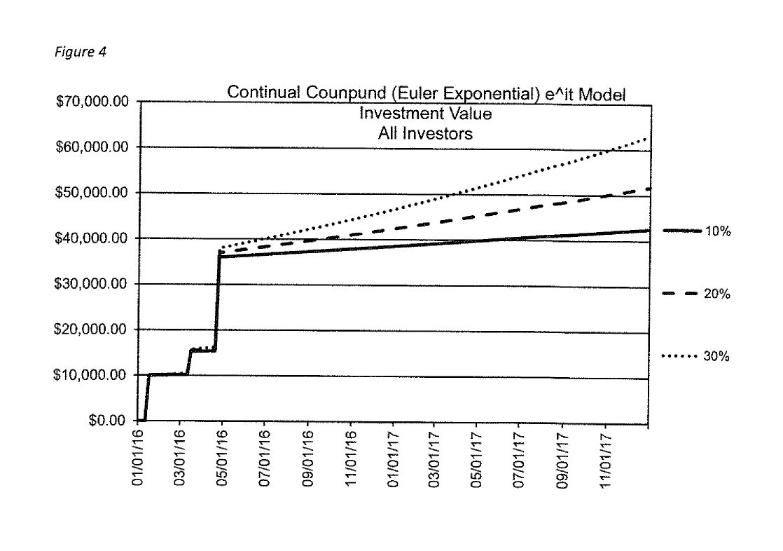

Continual compounding may be somewhat complex to understand mathematically, but it is actually simpler to deal with practically, because now there is just an annual interest rate, with no compounding period to deal with. The difference between continual compounding and daily compounding is actually quite small in effect. For i=10% or 0.1, daily compounding applied for one full year results in V=(1.105155942)P, and continual compounding over the same period results in V=(1.105170918)P, which is only 1.000013551 times larger, a pretty small difference! So generally it is simpler to just use continual compounding. Applying continual compounding to our Investment Value model, with the same multiple investor fact pattern as before, results in FIG. 4.

Risk is a key factor in obtaining a valuation for a startup. There is real risk and perceived risk, but they both tend to impact valuation. In generally, hopefully, if a startup is executing to its business plan, the risk will be at its highest point at the beginning, and will be generally decreasing as time goes on. There is no guarantee that this will be the result, but generally, as founders and other workers and contributors invest more funds and effort, daily progress and key milestones are achieved, and risk is reduced. Also, generally, as risk is reduced, the rate at with the risk is dropping gets more shallow, it does not generally continue to reduce risk at as fast of a slope as earlier risk reduction periods. This is generally true, in part because there is not as much total risk remaining to reduce as there is earlier. So, the rate at which risk is falling, begins to reduce because the total remaining risk is smaller than previously. If risk is reduced by 10%, that generally represents a much smaller change later, than previously, because the total remaining risk has become smaller. So, real risk is generally falling, but at a slower rate as time goes by.

Applying a curve fitting approach to the characterization of risk is similarly advantageous as applying curve fitting to valuation. It enforces the reasonable expectation that actual risk is probably changing somewhat consistently over time. It is reasonable to assume that the risk on December 1 is probably only incrementally adjusted from the risk present on November 1. There are developments and accomplishments that tend to cause people to consider that abrupt changes in risk have happen, but much of this is really just a perceived step change in the risk. If a patent issues, there was actually much incremental work that went in to the patent throughout all of it application and process. There may be a feeling of “good we finally have that patent”, but the reality is, the value was added a bit at a time, and the abrupt drop in risk that this might imply, was actually achieved in many smaller steps along the way. This tends to be true with all factors. Perceived risk, might have discontinuities and step changes in the curve, but wisdom would imply that spreading out the risk reduction over time is more real.

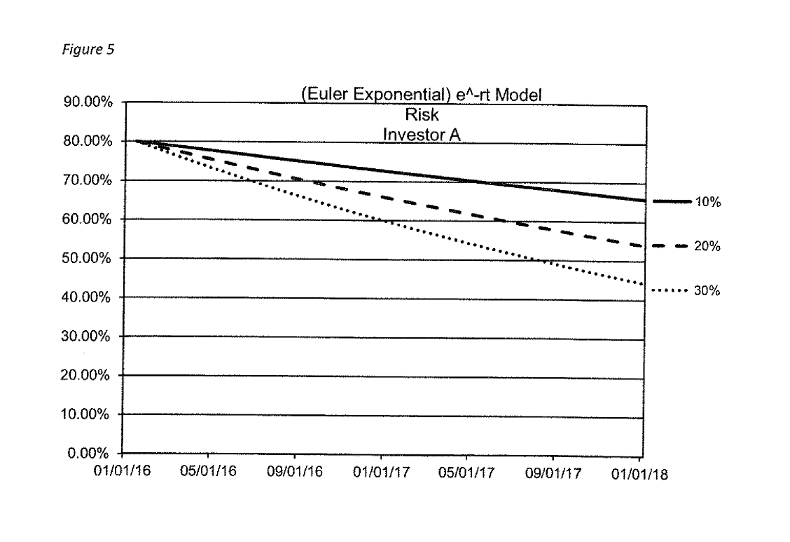

One mathematical model that fits the requirements and expectations described above for risk over time, is another exponential curve. However, this time using a negative exponent, with Euler's number again raised to a power, but this time to a negative power of time, eA-rt. Here, r is a number which determines the magnitude of the initial negative slope of the falling risk curve. A family of curves for risk is easily formed using this equation, and arbitrarily picking an 80% risk level as a starting point, as shown in FIG. 5.

However, the valuation curve as we have already defined it, already actually includes the effects of risk. The value that A round investors will pay, establishing the pre-money valuation at A round clearly already will include risk factors. Early contributions made by early investors throughout the period of the CR, are focused on addressing and reducing risk factors, which is fundamental to the daily execution of the start-up. So, these also in effect include risk factors.

Risk is generally understood to be inversely related to value. If risk follows a negative exponential as suggested above, then its effect on valuation would be 1/(ê-rt). This is easily combined with the equation for the valuation curve to become a valuation curve of: (êit)/(ê−rt), which further simplifies to be simply: ê(i+r)t. For the valuation curve, we are already allowing the effective interest variable to be a value that doesn't get firmly established until it is set to match the pre-money valuation at A round. So, what this latest equation shows, is that the value previous used for the interest rate i, actually fully includes all risk factors, and that the actual number used for i, is simply a combination of an interest rate, and a rate of risk reduction that has occurred throughout the pre-A round CFI period. So, when using a CFI there is no need to separately keep track of a numerical evaluation of what the risk factors are. There is certainly great value for investor and founder/entrepreneur alike to have the risks well understood, but the discipline brought to the valuation curve as described above, already necessarily includes risk factors, because the pre-money valuation at A round will certainly include a thorough risk analysis, and much of the money and effort invested has almost certainly been focused on reducing risks, and so the size of much of the investment speaks of the size of the risk, and the risk reduction. So, throughout the valuation curve as described earlier, risk is in fact, factored in.

As discussed above, bringing any predictability to the valuation process of an early stage startup would help to provide a benchmark to increase confidence in any particular valuation, with this all by itself tending to reduce funding risk. However, Bringing Model Based Analysis to bear on the valuation process of an early stage startup, while maintaining the adjustable flexibility of an undetermined slope variable, is a novel solution to this otherwise unwieldy problem, which dramatically reduces, or even virtually eliminates funding risk. This approach can easily be built into the terms of a security issued to investors in exchange for any cash investment, as well as issued to those whose contribution or investment is made in the form of effort. Using this approach, the precise value of any investment or contribution does not get fully determined until closing on a larger later round, (such as an A round), using a more robust market based pre-money valuation determined at that later time. At that later time, the value of the slope variable which causes the composite enterprise value to match the market determined pre-money valuation at the later round, can be utilized to select a single curve from the family of curves, and give all contributors or investors their equitable portion of the pre-money valuation in the form of stock as issued at the later round.

1. A method of funding a business enterprise comprising,
providing a security to investors in exchange for investment funds, wherein the security includes terms that legally binds the investor to accept future valuation of the investment determined by applying a time based mathematical model which projects a later value of the investment based on the value of the investment at the time it was made, and based upon a variable to be determined at consummation of a later round of funding.

2. A method of funding a business enterprise comprising,
providing a security to investors in exchange for investment funds in an enterprise, wherein the security includes terms that legally binds the investor to accept a future valuation of the investment.

3. The method of claim 2 where the determination of the future valuation of the
investment comprises the steps of,
applying a time based mathematical model which projects a later value of the investment based on the value of the investment at the time it was made,
combining the projected values of multiple investments made in the enterprise, to acquire a composite value for the enterprise,
modifying the value of a variable in the mathematical model to adjust the composite value to match a market based valuation,
determining the value of each of the multiple investments by utilizing the modified value of the variable in the mathematical model.

4. The method of claim 3, wherein modifying the value of a variable modifies the time based rate of change of the projected values.

5. The method of claim 3, where the composite value of a multiplicity of issued securities constitutes a valuation of the enterprise.

6. The method of claim 3, where said time based mathematical model includes a variable which can be adjusted to generate a family of similarly shaped curves based on the mathematical model.

7. The method of claim 6 where the variable is adjusted to achieve any value of time slope for any given time value of said model.

8. The method of claim 6, where said mathematical model is an exponential function having a base of Eulers number, raised to the power of interest rate times time.

9. The method of claim 6, further including the step of,
adjusting the variable at the end of one financing period of the company to match the combined value of all equities in the enterprise to the pre-money valuation negotiated as part of following round of funding.

10. The method of claim 3, further including forming a security as a basis for investing in an enterprise, where the portion of the enterprise that is owned or will be owned by each security holder is determined by the later value of each security holders investment compared to the composite value of the enterprise.

11. The method of claim 10, further including said comparison executed by dividing the later value of each security holders investment by the composite value of the enterprise, to determine the portion of the enterprise that is owned by each security holder.

12. The method determining the future valuation of an investment comprising the steps of,
applying a time based mathematical model which projects a later value of the investment based on the value of the investment at the time it was made,
combining the projected values of multiple investments made in the enterprise, to acquire a composite value for the enterprise,
modifying the value of a variable in the mathematical model to adjust the composite value to match a market based valuation, and
determining the value of each of the multiple investments by utilizing the modified value of the variable in the mathematical model.
